(19) United States
(12) Patent Application Publication
(10) Pub. No.: US 2026/0300710 A1
(43) Pub. Date: Oct. 1, 2026

(54) PHYSICAL COMPUTING ARCHITECTURE WITH DIRECT COUPLING OF EMERGENT RESULTING STATES WITHOUT REQUIRED INFORMATIONAL EXTRACTION

(71) Applicant: Anil P. Rami, MOUNDSVILLE, WV (US)

(72) Inventor: Anil P. Rami, MOUNDSVILLE, WV (US)

(21) Appl. No.: 19/708,993

(22) Filed: Jun. 16, 2026

Related U.S. Application Data
(63) Continuation-in-part of application No. 19/452,222, filed on Jan. 16, 2026.

(51) Int. Cl. G06N 3/063

(52) U.S. Cl. CPC G06N 3/063

(57) ABSTRACT

A physical computing architecture is disclosed in which emergent resulting states produced through transient physical evolution within a medium lacking stored computational routing topology are directly coupled to downstream systems. The resulting states arise from physical constraint resolution rather than predefined computational functions, and are therefore qualitatively distinct from states produced by conventional analog circuits such as thermocouples or operational amplifier circuits. Such emergent resulting states may influence downstream systems including actuators, processors, memory elements, communication systems, and other physical media without requiring informational extraction, decoding, or symbolic interpretation as a prerequisite. Observation and decoding may occur concurrently with direct state coupling but are optional rather than architecturally required. In certain embodiments the physical medium exhibits history-dependent parameter field modification from prior excitation. The disclosed architecture represents the direct-coupling branch of a three-branch framework comprising state formation, state interpretation, and direct state coupling, arising from the non-stored-topology physical computation family.

### CROSS-REFERENCE TO RELATED APPLICATIONS

This application is a continuation-in-part of U.S. patent application Ser. No. 19/452,222, titled “FIELD-BASED LIGHT COMPUTING WITHOUT STORED TOPOLOGY AND METHODS OF DECODING RESULTING FIELD STATES,” filed Jan. 15, 2026, the entirety of which is incorporated herein by reference. This application is further related to U.S. patent application Ser. No. 19/455,843, titled “NONLINEAR PHYSICAL COMPUTING ARCHITECTURE WITH SUBSTRATE-NATIVE MEMORY AND HISTORY-DEPENDENT COMPUTATION”; Ser. No. 19/547,362, titled “NONLINEAR PHYSICAL COMPUTING ARCHITECTURE WITH RESET-VERIFIED CONVERGENCE ACCELERATION AND KINETIC ENERGY MANAGEMENT”; Ser. No. 19/549,231, titled “NONLINEAR PHYSICAL COMPUTING ARCHITECTURE WITH DOMAIN-WIDE PARAMETER-FIELD RESHAPING, ATTRACTOR-LANDSCAPE MODIFICATION, GRADIENT PERSISTENCE MODULATION, AND MULTI-DOMAIN ORCHESTRATION”; Ser. No. 19/640,336, titled “NONLINEAR PHYSICAL COMPUTING ARCHITECTURE WITH DYNAMIC INTRA-SUBSTRATE DOMAIN SEGMENTATION AND CONTROLLED DOMAIN EVOLUTION”; Ser. No. 19/660,178, titled “PHYSICAL COMPUTING SYSTEM WITH NON-RECONSTRUCTIVE AND HIERARCHICAL FIELD-STATE DECODING”; Ser. No. 19/700,285, titled “CONSTRAINT-NATIVE COMPUTATION THROUGH CONTINUOUS RESOLUTION OF INTERACTING PHYSICAL CONSTRAINTS IN A MEDIUM LACKING STORED COMPUTATIONAL TOPOLOGY”; and Ser. No. 19/707,283, titled “PHYSICAL INFLUENCE PROPAGATION ARCHITECTURE: ACTUATION WITHOUT INTERMEDIATE CONTROL DETERMINATION”; the entireties of which are incorporated herein by reference.

### FIELD OF THE INVENTION

The present invention relates to physical computing systems implemented in continuous media and, more particularly, to systems and methods whereby resulting states produced through transient physical evolution within a medium lacking stored computational routing topology are directly coupled to downstream systems without requiring informational extraction, symbolic interpretation, output determination, or reconstruction as a prerequisite for downstream influence.

### BACKGROUND OF THE INVENTION

Conventional computing systems generally require that internal states be interpreted before they become useful. Digital systems generate intermediate representations that are subsequently evaluated, classified, decoded, or converted into outputs. Analog, neuromorphic, photonic, and physical computing systems similarly rely upon readout structures, output mappings, reconstruction procedures, or interpretation layers that determine what a resulting state means prior to utilization.

Even physical computing architectures that generate computation through distributed physical dynamics commonly assume that resulting states must be observed, measured, decoded, reconstructed, classified, or otherwise converted into an informational representation before they may influence external systems.

This assumption creates architectural separation between state formation and downstream influence, imposing informational extraction as a mandatory intermediate step.

The present disclosure recognizes that resulting states produced through transient physical evolution within a medium lacking stored computational routing topology are qualitatively distinct from states produced by circuits executing predefined computational functions. Such resulting states arise from physical constraint resolution, field dynamics, boundary conditions, material properties, and governing parameter fields rather than from predefined paths, stored mappings, or encoded computational topology. The distinction between a state produced by physical evolution in a non-stored-topology medium and a state produced by a predefined analog circuit—such as a thermocouple, a resistor network, or an op-amp circuit—is therefore not merely one of degree but of kind: the former reflects the resolution of physical constraints within an evolving medium, while the latter reflects the execution of a predefined functional relationship encoded in the circuit's structure prior to operation.

There remains a need for architectures in which emergent resulting states produced through physical evolution within non-stored-topology media may directly participate in downstream causation without requiring informational extraction as a prerequisite.

### SUMMARY OF THE INVENTION

The present invention provides a physical computing architecture comprising a physical medium configured to support transient physical evolution without stored computational routing topology, wherein the medium produces emergent resulting states through physical constraint resolution rather than through execution of predefined computational structure.

A resulting state produced within the medium is coupled to one or more downstream systems such that the resulting state directly influences said downstream systems. The resulting state need not first undergo informational extraction, symbolic interpretation, classification, reconstruction, output determination, or equivalent processing before participating in downstream influence.

In certain embodiments, observation, measurement, decoding, classification, interpretation, or informational extraction may occur concurrently with direct state coupling. However, such processes are optional and are not required for the resulting state to influence the downstream system. The architecture therefore permits direct state coupling and observation to occur simultaneously rather than sequentially.

In certain embodiments, the physical medium exhibits history-dependent parameter field modification arising from prior excitation, such that resulting states reflect accumulated prior physical evolution of the medium in addition to current input conditions.

The downstream system may comprise an actuator, processor, memory element, communication system, physical medium, electrical system, optical system, mechanical system, thermal system, magnetic system, software system, biological system, neural interface, or combinations thereof.

In certain embodiments, emergent resulting states of a first physical medium directly influence physical evolution within a second physical medium without intervening informational extraction, symbolic interpretation, output determination, or reconstruction. In such embodiments, the emergent resulting state produced by the first medium participates directly in the physical evolution of the second medium, without the resulting state first being decoded, classified, or converted into a symbolic or digital representation for the purpose of determining or generating inputs to the second medium. This substrate-to-substrate coupling architecture permits physical computing media to influence one another through direct physical causation rather than through mediated information transfer, and represents a first-class embodiment of the direct state coupling principle disclosed herein.

### DEFINITIONS

“Resulting State” refers to a physical state produced through transient evolution of a physical medium lacking stored computational routing topology, wherein said state arises from physical constraint resolution, field dynamics, boundary conditions, material properties, governing parameter fields, prior excitation history, or combinations thereof, rather than from execution of a predefined computational function encoded in the medium prior to operation.

“Emergent Resulting State” refers to a resulting state that was not predetermined by stored computational structure within the medium and that reflects resolution of physical constraints governing the medium's evolution. An emergent resulting state is distinguished from a state produced by a predefined analog circuit—such as a thermocouple, resistor network, or operational amplifier—in that the former arises from physical evolution within a medium lacking stored computational routing topology, while the latter arises from a predefined functional relationship encoded in circuit structure prior to operation.

“Physical Constraint” and “Physical Constraint Resolution” as used herein have the meanings set forth in U.S. patent application Ser. No. 19/700,285, titled “CONSTRAINT-NATIVE COMPUTATION THROUGH CONTINUOUS RESOLUTION OF INTERACTING PHYSICAL CONSTRAINTS IN A MEDIUM LACKING STORED COMPUTATIONAL TOPOLOGY,” incorporated herein by reference. Briefly, a physical constraint refers to a property, relationship, condition, interaction, governing relationship, or combination thereof that influences physical evolution of a medium during operation, and physical constraint resolution refers to evolution arising from interaction among two or more physical constraints influencing physical behavior of a medium. The presence of physical constraints within a medium and the resolution of those constraints through physical evolution distinguishes a non-stored-topology computational medium from a predefined analog circuit, in which the relationship between input and output is encoded in the circuit's structure prior to operation rather than arising from constraint resolution during operation.

“Direct State Coupling” refers to coupling in which an emergent resulting state directly influences a downstream system without informational extraction being required as a prerequisite for said influence.

“Informational Extraction” refers to observation, measurement, decoding, classification, symbolic conversion, output determination, interpretation, reconstruction, or combinations thereof performed for the purpose of determining meaning or output from a resulting state prior to downstream influence.

“Stored Computational Routing Topology” refers to physical structure configured to encode computational mappings, routing arrangements, logical organization, computational pathways, computational outcomes, or correspondences between inputs and outputs prior to operation. Physical constraints present within a medium do not constitute stored computational routing topology merely by virtue of influencing physical evolution, provided that such constraints do not encode predefined correspondences between inputs and outputs.

“Downstream System” refers to any system influenced by a resulting state.

### DETAILED DESCRIPTION

### Distinction Between Emergent Resulting States and Predefined Circuit Outputs

The present disclosure is founded on a distinction between two categories of physical state that is critical to understanding the scope of the claimed invention. The first category comprises states produced by physical media lacking stored computational routing topology, wherein states arise through transient physical evolution governed by physical laws, material properties, boundary conditions, governing parameter fields, and prior excitation history. The second category comprises states produced by physical circuits whose structure encodes a predefined computational function prior to operation, such as thermocouple voltage (predefined by the Seebeck coefficient and the material junction), resistor voltage (predefined by Ohm's law and the circuit topology), or operational amplifier output (predefined by feedback network topology and gain settings).

The distinction is not between analog and digital, nor between simple and complex, nor between continuous and discrete. A thermocouple is an analog physical system, yet its output is entirely predetermined by a material constant and the temperature difference at its junction—there is no sense in which the thermocouple's state emerged from transient physical evolution within a non-stored-topology medium. By contrast, a resulting state produced within a photorefractive medium, a ferroelectric domain system, or a field-evolution medium lacking stored computational routing topology reflects the resolution of physical constraints that were not predetermined by the medium's structure and that may depend on the medium's full prior excitation history.

Direct state coupling as claimed herein concerns the second category: emergent resulting states arising from physical evolution in non-stored-topology media. The architectural novelty is that such states—which are not the output of predefined circuits and which may encode complex physical constraint resolution and history-dependent dynamics—may directly influence downstream systems without first being extracted as informational representations.

### State Formation

A physical medium receives one or more input influences. The medium evolves according to physical laws, material properties, governing parameter fields, boundary conditions, environmental conditions, prior excitation history, or combinations thereof. Evolution produces one or more resulting states. The medium lacks stored computational routing topology and does not execute predefined computational paths or stored mappings. The resulting states arise from physical constraint resolution within the evolving medium.

The medium may comprise optical, electrical, magnetic, thermal, acoustic, mechanical, fluidic, chemical, biological, quantum, piezoelectric, photorefractive, ferroelectric, semiconductor, metamaterial, or multi-physical structures, provided that the medium lacks stored computational routing topology.

In certain embodiments, the medium exhibits history-dependent parameter field modification arising from prior excitation, such that governing parameter fields are reshaped by accumulated prior physical evolution and resulting states reflect said accumulated history.

### Direct State Coupling

The emergent resulting state produced within the medium is coupled to one or more downstream systems. The downstream system responds to the resulting state directly. The downstream system need not determine what the resulting state represents before influence occurs.

Influence may occur continuously, intermittently, transiently, persistently, or combinations thereof. The resulting state may directly modify electrical current, electrical voltage, magnetic field properties, optical transmission, mechanical force, mechanical position, memory state, processor state, communication state, physical configuration, actuator behavior, or combinations thereof.

### Optional Observation

Observation may occur concurrently with direct state coupling. Observation does not prevent direct state coupling. The architecture therefore permits the resulting state to influence a downstream system and to be observed simultaneously. Informational extraction is optional rather than architecturally required. In certain embodiments, a non-participatory observer reads the resulting state without preventing that state from also directly influencing a downstream system.

### Substrate-to-Substrate Coupling

In certain embodiments, the downstream system comprises a second physical medium configured to support transient physical evolution. In such embodiments, emergent resulting states of the first physical medium directly influence physical evolution within the second physical medium without intervening informational extraction, symbolic interpretation, output determination, or reconstruction. The emergent resulting state of the first medium participates directly in the physical evolution of the second medium—shaping its boundary conditions, field dynamics, governing parameter fields, or constraint landscape—without that resulting state first being decoded or converted into a symbolic representation used to determine inputs to the second medium.

This substrate-to-substrate coupling architecture is qualitatively distinct from conventional inter-system communication, in which information is extracted from one system, encoded, transmitted, decoded, and then used to determine the behavior of the second system. In the disclosed embodiment, physical causation passes directly from the first medium's resulting state into the second medium's evolution, without the encoding-transmission-decoding chain that conventional information transfer requires. Such substrate-to-substrate coupling enables networks of physical computing media to influence one another through direct physical causation, producing collective emergent behavior without centralized control or mediated information transfer.

### Relationship to Interpretation and Actuation Architectures

The present disclosure addresses one branch of a three-branch architectural framework arising from the non-stored-topology computation family. The first branch concerns the formation of emergent resulting states through physical evolution in non-stored-topology media, as disclosed in the related applications. The second branch concerns the interpretation of emergent resulting states through non-reconstructive, non-participatory observation, as disclosed in the related application directed to non-reconstructive field-state decoding. The third branch, disclosed herein, concerns the direct coupling of emergent resulting states to downstream systems without required informational extraction. The present application discloses the third branch and should be understood in the context of the full architectural framework.

The related application directed to constraint-native computation (U.S. patent application Ser. No. 19/700,285) discloses, in certain embodiments, that observed physical states may directly influence physical action without symbolic representation of intermediate computational states, and that observed physical states may be coupled directly to actuators. The present disclosure extends this principle beyond actuator coupling and physical action to encompass direct coupling of emergent resulting states to downstream systems generally, including processors, memory elements, communication systems, additional physical computing substrates, biological systems, neural interfaces, and other systems. The architectural principle disclosed herein—that emergent resulting states may directly influence downstream systems without required informational extraction—applies to the full range of downstream systems to which such states may be coupled, and is not limited to the actuator-coupling and physical-action embodiments described in application Ser. No. 19/700,285. This broader scope represents the primary distinguishing contribution of the present disclosure relative to that related application.

The present application is further related to U.S. patent application Ser. No. 19/707,283, titled “PHYSICAL INFLUENCE PROPAGATION ARCHITECTURE: ACTUATION WITHOUT INTERMEDIATE CONTROL DETERMINATION.” The relationship between the two disclosures is as follows: application Ser. No. 19/707,283 concerns the propagation pathway from sensing elements to actuator elements within a real-time actuation pathway, and is defined by the absence of intermediate control determination within that pathway. Direct state coupling as disclosed herein concerns a different architectural relationship: the propagation from emergent resulting states produced within a non-stored-topology computational substrate to downstream systems generally, and is defined by the absence of required informational extraction as a prerequisite for that downstream influence. Application Ser. No. 19/707,283 addresses what happens in the pathway between sensing and acting. The present disclosure addresses what happens at the boundary between substrate-level computation and downstream influence across the full range of possible downstream systems. A system may embody both architectural principles simultaneously—non-reconstructive actuation governing the sensing-to-actuation pathway while direct state coupling governs the relationship between the substrate's emergent resulting states and their downstream effects—or either principle may be embodied independently of the other.

1. A physical computing system comprising: a physical medium configured to support transient physical evolution, wherein said physical medium lacks stored computational routing topology and wherein said physical evolution produces a resulting state arising from physical constraint resolution within said medium rather than from execution of a predefined computational function encoded in said medium prior to operation; and a coupling pathway configured to permit said resulting state to directly influence one or more downstream systems selected from the group consisting of processors, memory elements, communication systems, actuator elements, additional physical computing substrates, biological systems, neural interfaces, electrical systems, optical systems, mechanical systems, thermal systems, magnetic systems, software systems, and combinations thereof; wherein informational extraction is not required as a prerequisite for said downstream influence.

2. The system of claim 1, wherein said resulting state reflects accumulated prior excitation history of said medium through history-dependent modification of one or more governing parameter fields of said medium.

3. The system of claim 1, wherein said one or more downstream systems comprise a processor, and wherein said resulting state directly modifies processor state without prior symbolic interpretation of said resulting state.

4. The system of claim 1, wherein said one or more downstream systems comprise a memory element, and wherein said resulting state directly modifies memory state without prior output determination.

5. The system of claim 1, wherein said one or more downstream systems comprise a communication system, and wherein said resulting state directly influences communication state without prior informational extraction.

6. The system of claim 1, wherein said one or more downstream systems comprise a second physical medium configured to support transient physical evolution, such that emergent resulting states of said physical medium directly influence physical evolution of said second physical medium without required informational extraction between said media.

7. The system of claim 1, wherein said one or more downstream systems comprise an actuator element configured to produce a physical response based on said resulting state without intermediate control determination.

8. The system of claim 1, wherein observation of said resulting state occurs concurrently with direct downstream influence without preventing said direct downstream influence.

9. The system of claim 1, wherein decoding of said resulting state by a non-participatory observer is optional and occurs without preventing direct downstream influence.

10. The system of claim 1, wherein said resulting state directly modifies an electrical property of said one or more downstream systems.

11. The system of claim 1, wherein said resulting state directly modifies an optical property of said one or more downstream systems.

12. The system of claim 1, wherein said resulting state directly modifies a mechanical property of said one or more downstream systems.

13. The system of claim 1, wherein said coupling pathway comprises at least one of: an optical coupling, a piezoelectric coupling, a magnetic coupling, an acoustic coupling, a mechanical coupling, a fluidic coupling, a capacitive coupling, an inductive coupling, a thermal coupling, or combinations thereof.

14. The system of claim 1, wherein said physical medium comprises at least one of: a photorefractive medium, a ferroelectric medium, a piezoelectric medium, a photonic medium, an acoustic medium, a magnetic medium, a fluidic medium, a thermal medium, a chemical medium, a biological medium, a quantum medium, or combinations thereof.

15. A method comprising: allowing a physical medium lacking stored computational routing topology to undergo transient physical evolution producing a resulting state arising from physical constraint resolution within said medium; and coupling said resulting state to one or more downstream systems selected from the group consisting of processors, memory elements, communication systems, actuator elements, additional physical computing substrates, biological systems, neural interfaces, and combinations thereof; wherein said resulting state directly influences said one or more downstream systems without requiring informational extraction as a prerequisite for said influence.

16. The method of claim 15, further comprising observing said resulting state concurrently with said direct downstream influence without requiring said observation as a prerequisite for said influence.

17. The method of claim 15, wherein said resulting state reflects accumulated prior excitation history of said medium through history-dependent modification of governing parameter fields of said medium.

18. The method of claim 15, wherein said one or more downstream systems comprise a second physical medium configured to support transient physical evolution, and wherein said direct coupling permits emergent resulting states of said physical medium to influence physical evolution of said second physical medium without intervening informational extraction.
